(19) United States
(12) Patent Application Publication
(10) Pub. No.: US 2009/0173815 A1
(43) Pub. Date: Jul. 9, 2009

(54) FISHING REEL HAVING TWO BRAKE DEVICES

(76) Inventor: WEN-HSIANG LEE, Taichung County (TW)

Correspondence Address: FOLEY AND LARDNER LLP;SUITE 500, 3000 K STREET NW, WASHINGTON, DC, 20007, US

(21) Appl. No.: 12/333,957

(22) Filed: Dec. 12, 2008

(30) Foreign Application Priority Data
Jan. 8, 2008 (TW) 097100703

(51) Int. Cl. A01K 89/033; A01K 89/015

(52) U.S. Cl. 242/286

(57) ABSTRACT

A fishing reel includes a housing, a spool, a first brake device, and a second brake device. The first brake device is operable to apply a first braking force to brake the rotation of the spool in a direction of unwinding a fishing line from the spool. The fishing line can be unwound from the spool only when an external force transmitted onto the spool via the fishing line is larger than the first braking force. The second brake device is operable to apply a second braking force to brake the rotation of the spool in the direction. The second braking force is smaller than the first braking force and the weight of a lure attached to the fishing line.

### CROSS-REFERENCE TO RELATED APPLICATION

This application claims priority of Taiwanese Application No. 097100703, filed on Jan. 8, 2008.

### BACKGROUND OF THE INVENTION

1. Field of the Invention

This invention relates to a fishing reel, and more particularly to a fishing reel having two brake devices.

2. Description of the Related Art

In boat fishing, after a lure attached to a fishing line is put into the water, it moves downwardly from the water surface at a high speed by virtue of gravity. As a result, the fish-inducing effect of the lure is reduced.

### SUMMARY OF THE INVENTION

The object of this invention is to provide a fishing reel that has two brake devices, one of which is operable to allow a lure to move downwardly from the water surface at a low speed to promote the fishing-inducing effect of the lure.

According to this invention, there is provided a fishing reel comprising:

a housing;

a spool disposed rotatably within the housing and extending along an axis, the spool being adapted to permit a fishing line to be wound thereon;

a first brake device operable to apply a first braking force to brake rotation of the spool in a line-unwinding direction of unwinding the fishing line from the spool such that the fishing line can be unwound from the spool only when an external force transmitted onto the spool via the fishing line is larger than the first braking force; and

a second brake device operable to apply a second braking force to brake the rotation of the spool in the line-unwinding direction, the second braking force being smaller than the first braking force and the weight of a lure attached to an end of the fishing line;

wherein, when only the second braking force is applied and when the lure moves downwardly from the water surface by virtue of gravity, the speed of the lure is reduced.

### BRIEF DESCRIPTION OF THE DRAWINGS

These and other features and advantages of this invention will become apparent in the following detailed description of a preferred embodiment of this invention, with reference to the accompanying drawings, in which:

FIG. 1 is a schematic view of the preferred embodiment of a fishing reel according to this invention;

FIG. 2 is a side view of the preferred embodiment;

FIG. 3 is a sectional view taken along line III-III in FIG. 2;

FIG. 4 is a sectional view taken along line IV-IV in FIG. 1;

FIG. 5 is a sectional view taken along line V-V in FIG. 2, illustrating inner and outer couplers in an engaged state;

FIGS. 6 and 7 are fragmentary, exploded perspective views of the preferred embodiment, viewed in different directions;

FIG. 8 is a view similar to FIG. 5 but illustrating the inner and outer couplers in a disengaged state;

FIG. 9 is a schematic view illustrating a sliding plate and a reset knob of the preferred embodiment, which are disposed respectively in a non-clicking position and a first position;

FIG. 10 is a schematic view similar to FIG. 9 but illustrating the sliding plate and the reset knob in a clicking position and a second position, respectively;

FIG. 11 is a schematic view similar to FIGS. 9 and 10 but illustrating the sliding plate and the reset knob in the non-clicking position and a third position, respectively;

FIG. 12 is a view similar to FIG. 3 but illustrating how a brake plate is moved indirectly by a cam member to adjust the pressure of a brake plate against a braking disk; and

FIG. 13 is a view similar to FIG. 4 but illustrating how the cam member is rotated by an operating member.

### DETAILED DESCRIPTION OF THE PREFERRED EMBODIMENT

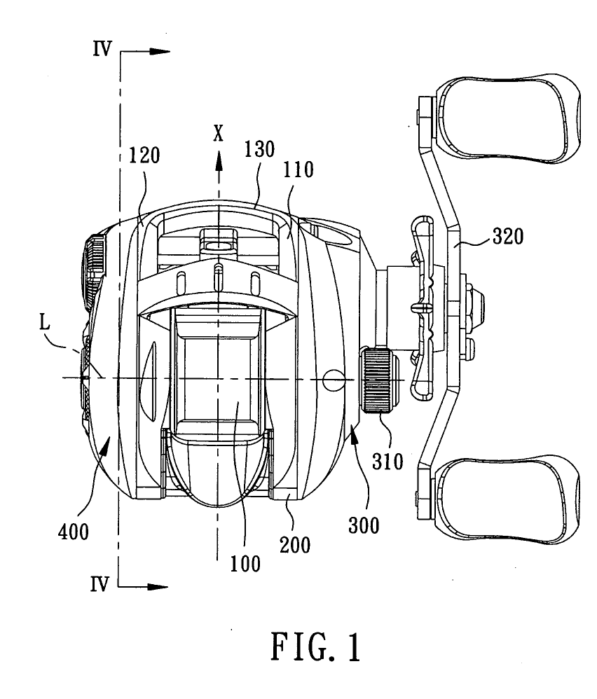

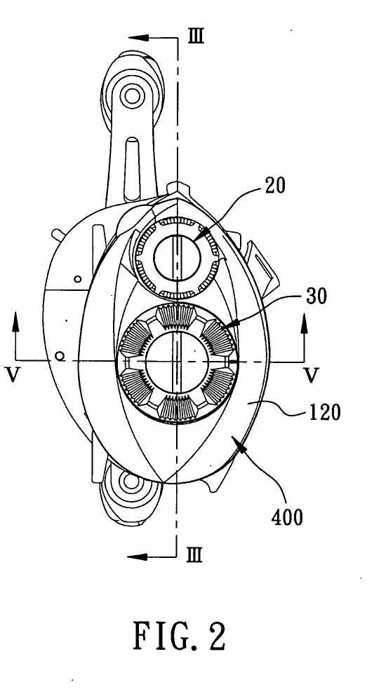

Referring to FIGS. 1 and 2, the preferred embodiment of a fishing reel according to this invention is used for boat fishing, and includes a housing 100, a spool 200 disposed rotatably within the housing 100 and permitting a fishing line to be wound thereon, a first brake device 300 operable to apply a first braking force to brake the rotation of the spool 200 in a line-unwinding direction of unwinding the fishing line from the spool 200 in a direction (X), and a second brake device 400 operable to apply a second braking force to brake the rotation of the spool 200 in the line-unwinding direction. Each of the first and second brake devices 300, 400 is convertible between an operating state and an idle state. The second braking force is smaller than the first braking force and the weight of a lure (not shown) attached to an end of the fishing line.

In a situation where only the first braking force is applied to the spool 200 (i.e., the first brake device 300 is in the operating sate, and the second brake device 400 is in the idle state), when an external force transmitted onto the spool 200 via the fishing line is larger than the first braking force, the fishing line is unwound from the spool 100.

In a situation where only the second braking force is applied to the spool 200 (i.e., the first brake device 300 is in the idle state, and the second brake device 400 is in the operating state), when the lure moves downwardly from the water surface by virtue of gravity, the speed of the lure is reduced, thereby promoting the fish-inducing effect of the lure of the lure.

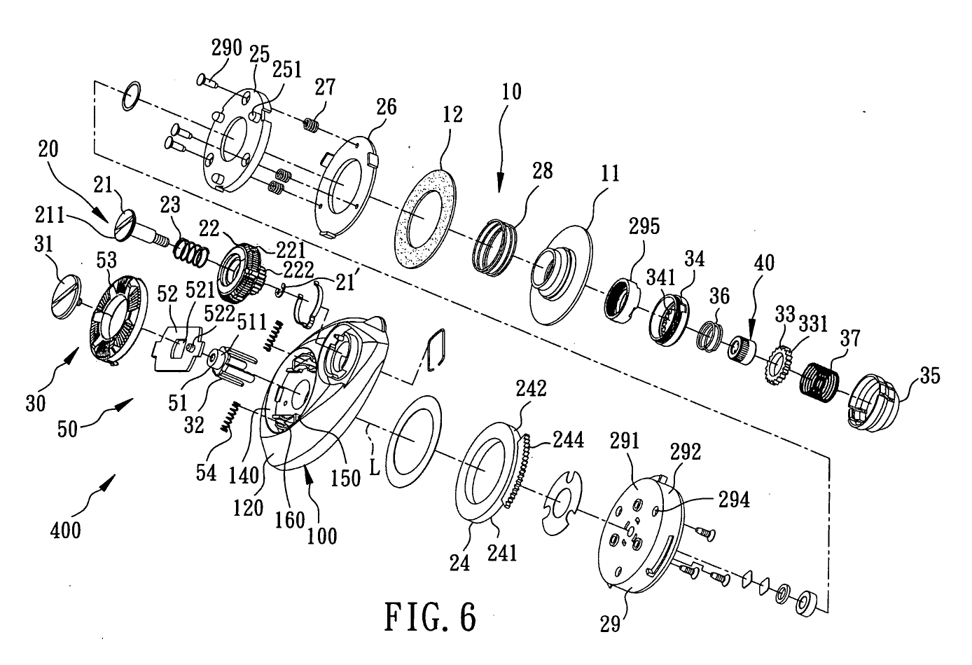

With further reference to FIG. 6, the housing 100 has opposite first and second sides 110, 120, and a plurality of coupling ribs 130 interconnecting fixedly the first and second sides 110, 120. The second side 120 has a circular accommodating groove 140, a slideway 150 in spatial communication with the circular accommodating groove 140 and extending in a radial direction of the circular accommodating groove 140, and two curved spring-receiving slots 160 extending in a circumferential direction of the circular accommodating groove 140. The slideway 150 is disposed between the spring-receiving slots 160.

The spool 200 extends along an axis (L) from the first side 110 to the second side 120.

The first and second brake devices 300, 400 are disposed respectively on two opposite ends of the spool 200, and are received respectively within the firs and second sides 110, 120.

The first brake device 300 includes an adjusting member 310 operable to adjust the first braking force, and a handle 320. Since the structure and operation of the first brake device 300 are known in the art, further description thereof will be omitted.

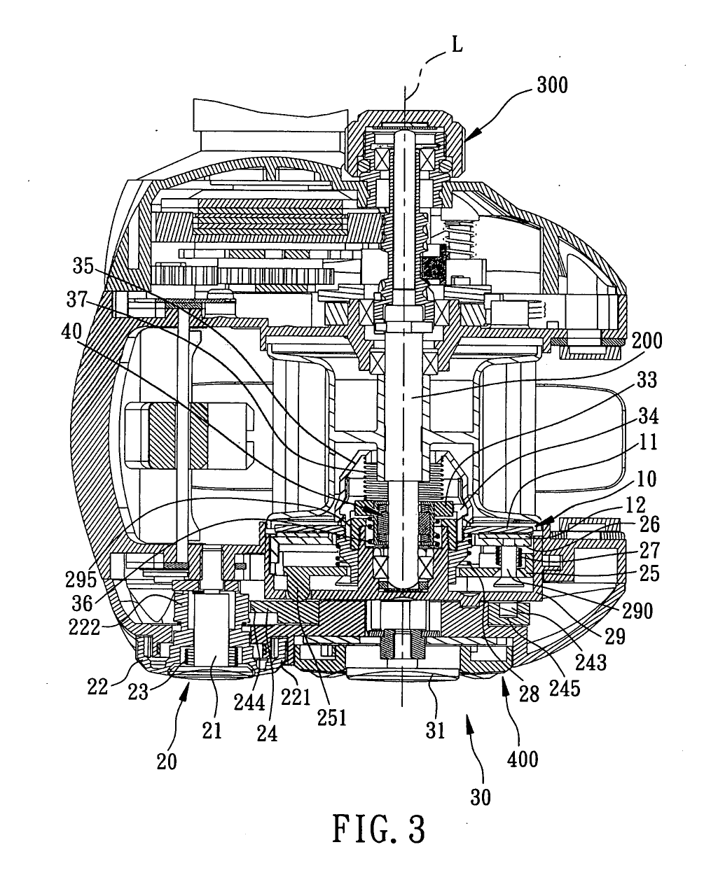

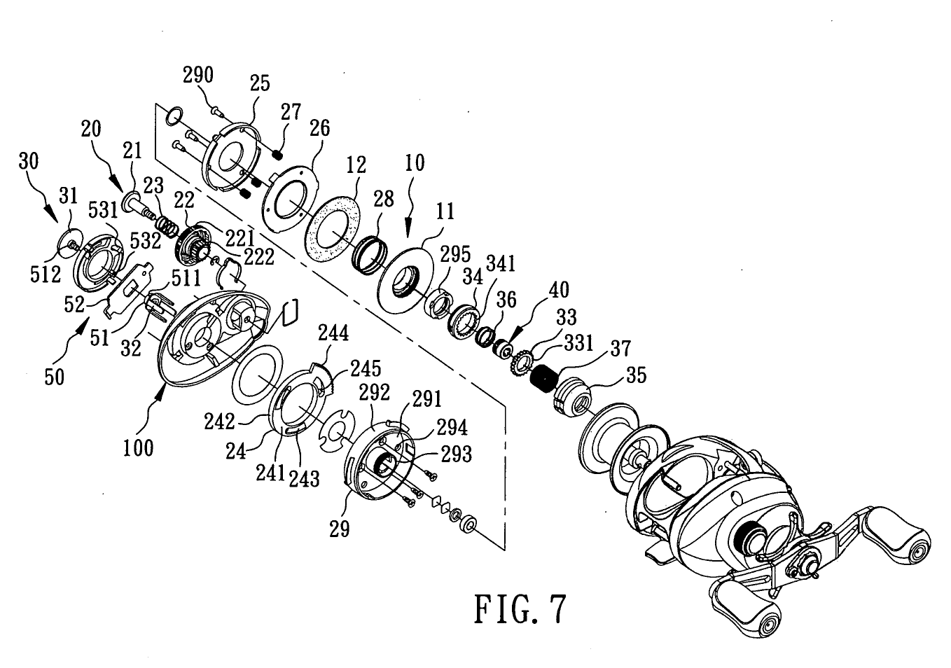

With further reference to FIGS. 3 and 7, the second brake device 400 includes a braking unit 10, a resistance-adjusting unit 20, a clutch unit 30, a unidirectional bearing 40, and a positioning unit 50.

The braking unit 10 includes a brake disk 11 sleeved rotatably on the spool 200, and a brake plate 12 sleeved movably on the spool 200 and biased to press against the brake disk 11 so as to apply the second braking force, thereby braking the rotation of the spool 200 in the line-unwinding direction, as described hereinafter.

The resistance-adjusting unit 20 includes a pivot pin 21, a C-ring 21′ for retaining the pivot pin 21 on the housing 100, a rotary knob 22 disposed on the housing 100 and rotatable about the pivot pin 21, a coiled compression spring 23 sleeved on the pivot pin 21 between a head 211 of the pivot pin 21 and the rotary knob 22, a cam member 24 driven by the rotary knob 22 to rotate, a follower 25 driven by the cam member 24 to move along the axis (L), a driven plate 26 disposed between the follower 25 and the brake plate 12 and connected fixedly to and parallel to the brake plate 12, a plurality of parallel guide pins 290 extending through the follower 25 and the driven plate 26 for guiding movement of the follower 25 and the driven plate 26 along the axis (L), a spring unit 27 consisting of a plurality of coiled compression springs sleeved respectively on the guide pins 290 between the follower 25 and the driven plate 26 for biasing the brake plate 12 toward the brake disk 11, a resilient member 28 for biasing the follower 25 toward the cam member 24, and a cylindrical receiving member 29 disposed removably on the housing 100.

The rotary knob 22 has an actuator portion 221 disposed outwardly of the housing 100, and a gear portion 222 disposed in the housing 100.

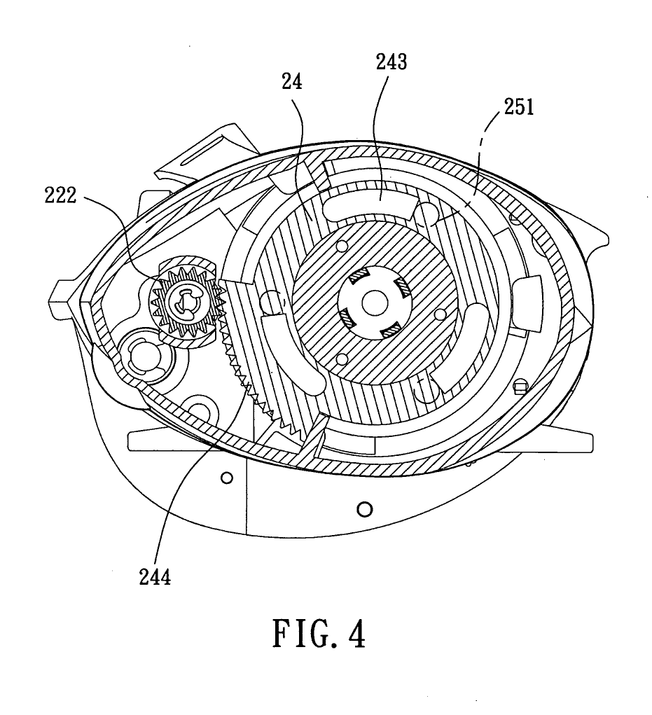

The cam member 24 has two opposite side surfaces 241, an annular peripheral surface 242 interconnecting outer peripheries of the side surfaces 241, a plurality of guide slots 243 formed in one of the side surfaces 241 and defined respectively by inclined cam faces 245, and a sector gear 244 disposed fixedly on the peripheral surface 242 and meshing with the gear portion 222 of the rotary knob 22, as shown in FIG. 4.

The follower 25 is formed with a plurality of integral projecting rods 251 biased by the resilient member 28 to contact the cam faces 245, respectively. As such, the projecting rods 251 can move respectively within the guide slots 243 in the cam member 24.

The cylindrical receiving member 29 has an end wall 291 disposed between the cam member 24 and the follower 25, a surrounding wall 292 extending axially from the outer periphery of the end wall 291, and an annular spool seat 293 extending axially from the end wall 291 and disposed in and spaced apart from the surrounding wall 292. The end wall 291 is formed with a plurality of holes 294 allowing the projecting rods 251 to extend respectively therethrough. An end of the spool 200 is disposed rotatably within the spool seat 293. The follower 25, the driven plate 26, and the spring unit 27 are received within the receiving member 29, and constitute cooperatively a movable member. The movable member is driven by the rotary knob 22 to move the brake plate 12 toward or away from the brake disk 11 along the axis (L). A positioning nut 295 is connected threadedly to the pool seat 293, and is contact with the brake disk 11 such that the brake disk 11 is confined rotatably between the receiving member 29 and the positioning nut 295.

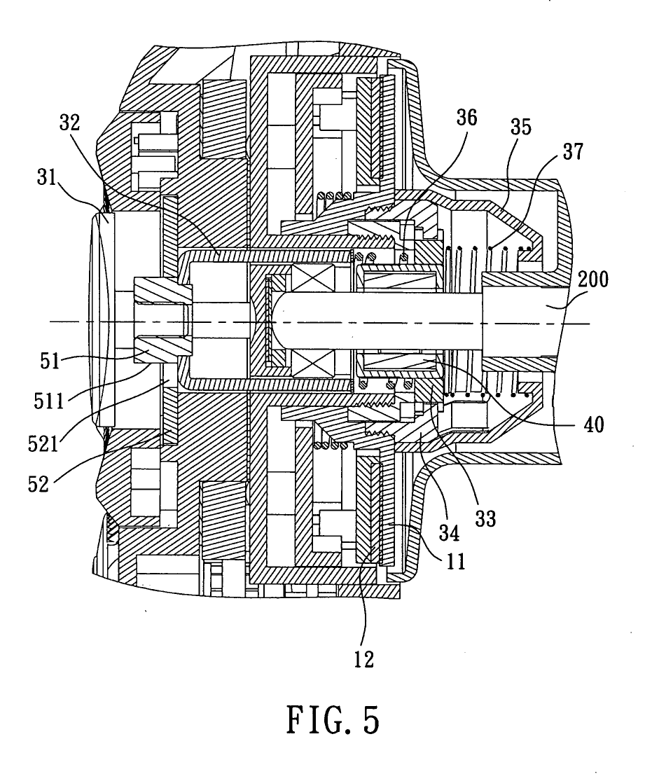

With further reference to FIG. 5, the clutch unit 30 includes an operating member 31 disposed movably on the housing 100, a pushing member 32 connected fixedly to the operating member 31, an inner coupler 33 driven indirectly by the pushing member 32 to move along the axis (L), an outer coupler 34 disposed within and connected threadedly to the brake disk 11, a cap 35 sleeved on the outer coupler 34 in a tight fitting manner, a first spring 36 disposed between the pushing member 32 and the inner coupler 33, and a second spring 37 disposed between the inner coupler 33 and the cap 35. The outer coupler 34 has an internal tooth portion 341. The inner coupler 33 has an external tooth portion 331 movable to engage the internal tooth portion 341 of the outer coupler 34.

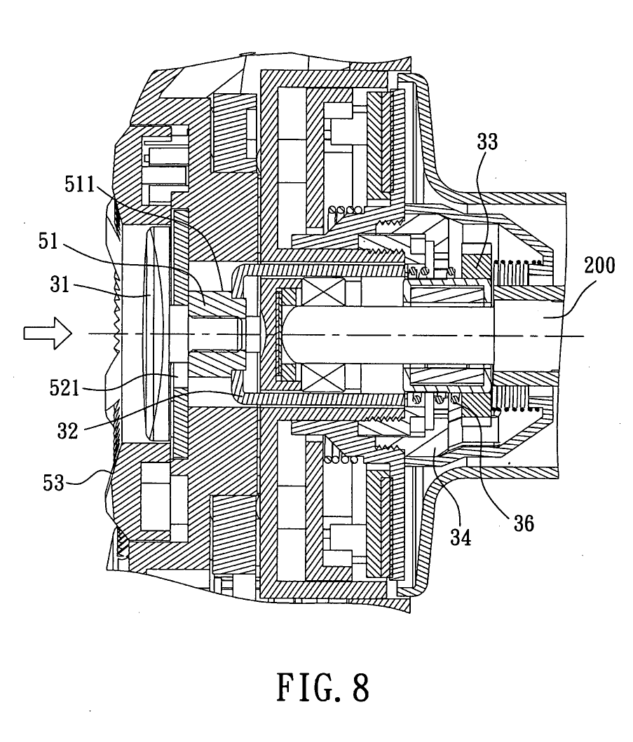

The operating member 31 is movable relative to the housing 100 between a non-depressed position shown in FIG. 5 and a depressed position shown in FIG. 8. In the non-depressed position, the external tooth portion 331 of the inner coupler 33 engages the internal tooth portion 341 of the outer coupler 34. In the depressed position, the external tooth portion 331 of the inner coupler 33 is removed from the internal tooth portion 341 of the outer coupler 34. The first spring 36 has a modulus of elasticity larger than that of the second spring 37. When the operating member 31 is disposed in the non-depressed position, the first spring 36 is in a non-compressed state, and the second spring 37 biases the external tooth portion 331 of the inner coupler 33 to engage the internal tooth portion 341 of the outer coupler 34.

The unidirectional bearing 40 is disposed fixedly within the inner coupler 33, and is sleeved movably on the spool 200.

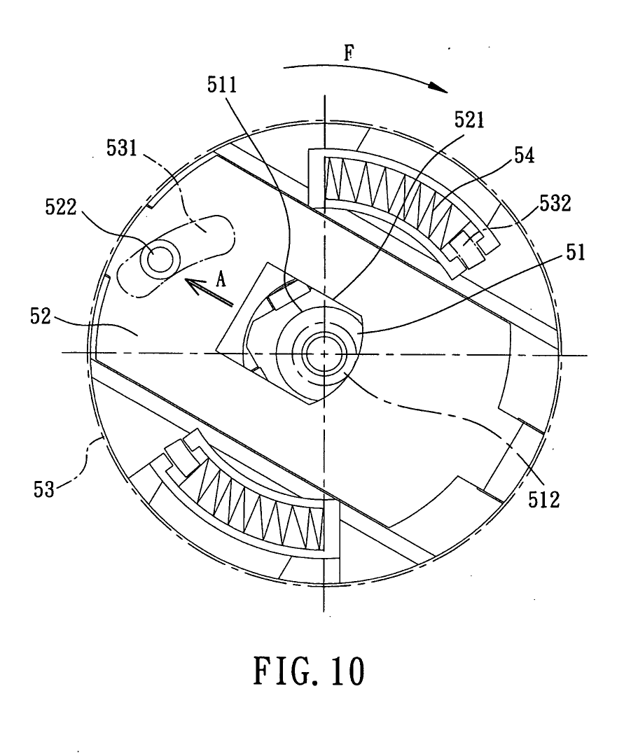

The positioning unit 50 is used for maintaining the operating member 31 in the depressed position, and includes a stepped member 51 interconnecting fixedly the operating member 31 and the pushing member 32, a sliding plate 52 movable relative to the housing 100 in a direction perpendicular to the axis (L), a circular reset knob 53 rotatable about the axis (L), and two return springs 54 for biasing the reset knob 53 to rotate in a clockwise or forward direction (F) (see FIG. 10).

The stepped member 51 has a large-diameter portion 511 connected fixedly to the pushing member 32, and a small-diameter portion 512 interconnected fixedly between the operating member 31 and the large-diameter portion 511 and having a diameter smaller than those of the operating member 31 and the large-diameter portion 511.

The sliding plate 52 has a hole 521, and a guiding rod 522 projecting from a side surface thereof confronting the reset knob 53. The stepped member 51 extends through the hole 521 in the sliding plate 52.

The reset knob 53 is sleeved rotatably on the operating member 31, is disposed within the circular accommodating groove 140 in the housing 100, and is formed with a slide slot 531 extending in a direction inclined relative to a radial direction of the reset knob 53, and two spring-engaging blocks 532 disposed respectively within the spring-receiving slots 160.

The return springs 54 are disposed respectively within the spring-receiving slots 160, and abut respectively against the spring-engaging blocks 532.

Since the return springs 54 bias the reset knob 53 to rotate in the forward direction (F) (see FIG. 10), as described above, and since the guiding rod 522 of the sliding plate 52 is movable within the slide slot 531 in the reset knob 53, the sliding plate 52 is biased to move relative to the housing 100 in a first direction (A) (see FIG. 10).

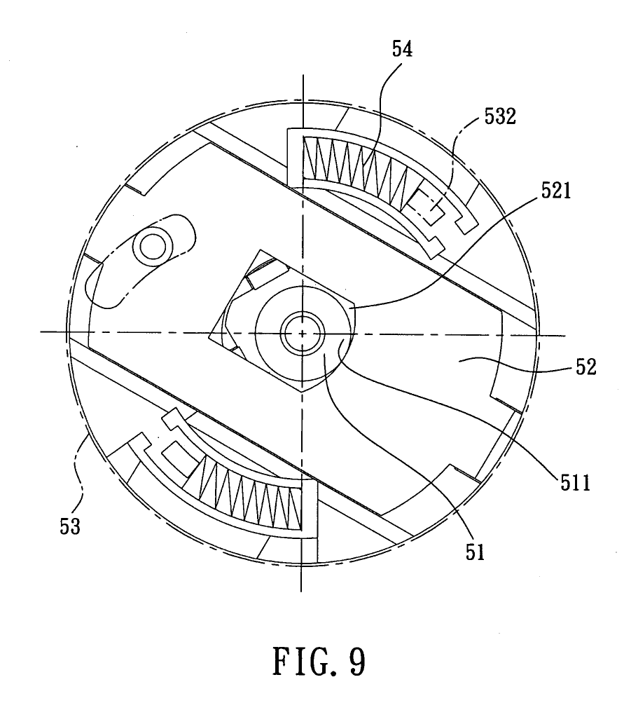

As such, when the operating member 31 is disposed in the non-depressed position, the sliding plate 52 is disposed in a non-clicking position, and the reset knob 53 is disposed in a first position whereat each of the return springs 54 is in a semi-compressed state, as shown in FIG. 9. In the non-clicking position, the sliding plate 52 is biased by the return springs 54 to abut against the large-diameter portion 511 of the stepped member 51. When the operating member 31 is moved to the depressed position, the sliding plate 52 is moved to a clicking position, and the reset knob 53 is rotated to a second position whereat each of the return springs 54 is in a non-compressed state, as shown in FIG. 10. In the clicking position, the sliding plate 52 is biased by the return springs 54 to abut against the small-diameter portion 512 of the stepped member 51 so as to be confined between the operating member 31 and the large-diameter portion 511 of the stepped member 51, thereby maintaining the external tooth portion 331 of the inner coupler 33 and the internal tooth portion 341 of the outer coupler 34 in an engaged state. As a consequence, movement of the sliding plate 52 from the non-clicking position to the clicking position results in rotation of the reset knob 53 relative to the housing 100 from the first position to the second position in the forward direction (F).

With particular reference to FIGS. 5 and 9, when the operating member 31 is disposed in the non-depressed position so as to engage the external tooth portion 331 of the inner coupler 33 with the internal tooth portion 341 of the outer coupler 34, i.e., the inner and outer couplers 33, 34 are in an engaged state, since the inner and outer couplers 33, 34 are connected respectively and fixedly to the unidirectional bearing 40 and the brake disk 11, the brake disk 11 is co-rotatable with the spool 200. As a result, the second braking force is applied to the brake disk 11 and, thus, the spool 200 by the brake plate 12. In other words, the second brake device 400 is in the operating state. In this state, the sliding plate 52 is sleeved on the large-diameter portion 511 of the stepped member 51, and each of the return springs 54 is in the semi-compressed state, as described above, as shown in FIG. 10.

When it is desired to convert the second brake device 400 from the operating state into the idle state, the operating member 31 is depressed, as shown in FIG. 8. Hence, the first spring 36 is compressed and moved by the pushing member 32 to push and remove the inner coupler 33 from the outer coupler 34. As a result, rotation of the spool 200 cannot be transferred to the brake disk 11. That is, no braking force is applied to the spool 200 by the brake plate 12. During depressing of the operating member 31, as shown in FIG. 10, the stepped member 51 moves along with the operating member 31 to align the sliding plate 52 with the small-diameter portion 512 of the stepped member 51. Hence, each of the return springs 54 rotates the reset knob 53 in the forward direction, and is converted into the non-compressed state so as to move the sliding plate 52 to the clicking position, thereby maintaining the second brake device 400 in the idle state.

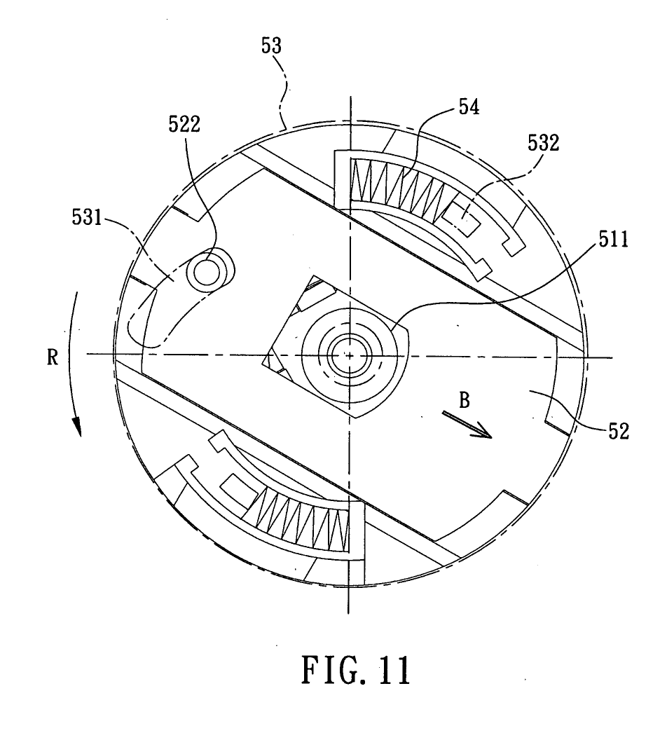

With particular reference to FIG. 11, when it is desired to convert the second brake device 400 from the idle state into the operating state, a knob-operating force is applied to rotate the reset knob 53 in a counterclockwise or reverse direction (R) from the second position to a third position whereat the sliding plate 52 comes into contact with a wall defining the circular accommodating groove 140 and whereat each of the return springs 54 is in a fully compressed position, as shown in FIG. 11, such that the reset knob 53 rotates past the second position. Rotation of the reset knob 53 from the second position to the third position results in movement of the sliding plate 52 relative to the housing 100 in a second direction (B) opposite to the first direction (A). When the reset knob 53 is disposed in the third position, since the stepped member 51 is spaced apart from and movable within the sliding plate 52, the operating member 31 is biased by the first spring 36 to return to the non-depressed position to thereby align the sliding plate 52 with the large-diameter portion 511 of the stepped member 51 so that the first spring 36 is converted into the non-compressed state, and the inner coupler 33 is biased by the second spring 37 to engage the outer coupler 34. Subsequently, the knob-operating force is released so that the reset knob 53 is biased by the return springs 54 to rotate from the third position to the first position to thereby abut against the large-diameter portion 511 of the stepped member 51.

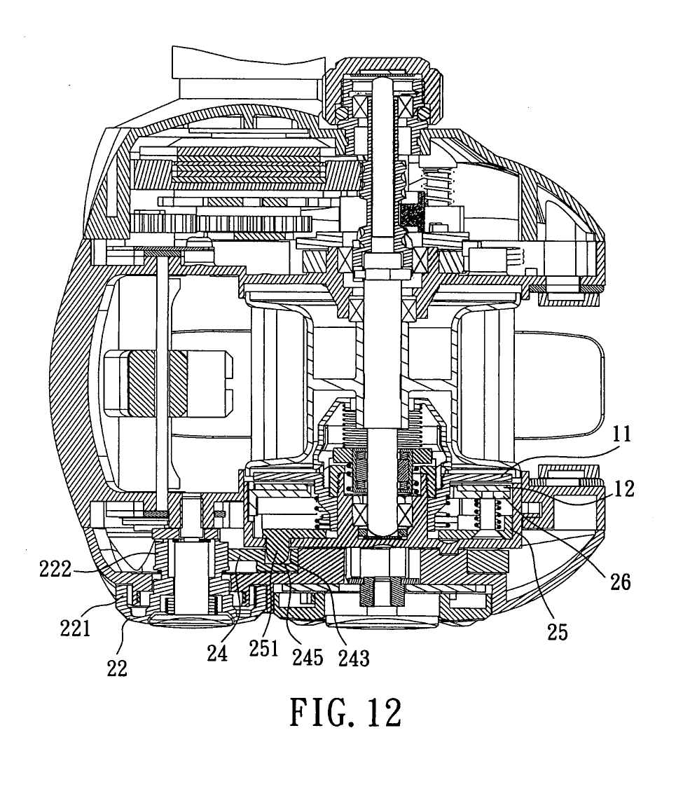

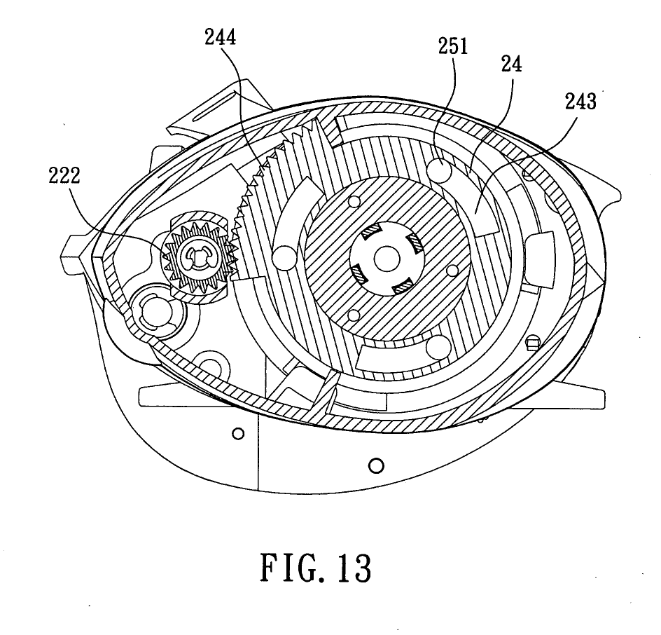

With further reference to FIGS. 12 and 13, to adjust the second braking force, it is only necessary to rotate the actuator portion 221 of the rotary knob 22. Due to engagement between the gear portion 222 of the rotary knob 22 and the sector gear 244 of the cam member 24, rotation of the rotary knob 22 is transferred to the cam member 24. When the cam member 24 rotates relative to the housing 100, the cam faces 245 move the projecting rods 251 of the follower 25, respectively, to change the extent of the first spring 36 to be compressed and, thus, the pressure of the brake plate 12 against the brake disk 11. In FIGS. 12 and 13, the pressure of the brake plate 12 against the brake disk 11 is zero.

With this invention thus explained, it is apparent that numerous modifications and variations can be made without departing from the scope and spirit of this invention. It is therefore intended that this invention be limited only as indicated by the appended claims.

I claim:

1. A fishing reel comprising:
a housing;
a spool disposed rotatably within said housing and extending along an axis, said spool being adapted to permit a fishing line to be wound thereon;
a first brake device operable to apply a first braking force to brake rotation of said spool in a line-unwinding direction of unwinding the fishing line from said spool such that the fishing line can be unwound from said spool only when an external force transmitted onto said spool via the fishing line is larger than said first braking force; and
a second brake device operable to apply a second braking force to brake the rotation of said spool in the unwinding direction, said second braking force being smaller than said first braking force and the weight of a lure attached to an end of the fishing line;
wherein, when only said second braking force is applied and when the lure moves downwardly from the water surface by virtue of gravity, the speed of the lure is reduced.

2. The fishing reel as claimed in claim 1, wherein said first and second brake devices are disposed respectively on two opposite ends of said spool, and are received respectively within two opposite sides of said housing.

3. The fishing reel as claimed in claim 2, wherein said second brake device includes a braking unit, said braking unit including a brake disk sleeved rotatably on said spool, and a brake plate sleeved movably on said spool and biased to press against said brake disk so as to apply said second braking force to brake the rotation of said brake disk.

4. The fishing reel as claimed in claim 3, wherein said second brake device further includes a resistance-adjusting unit, said resistance-adjusting unit including an rotary knob disposed rotatably on said housing, and a movable member driven by said rotary knob to move said brake plate toward or away from said brake disk along the axis.

5. The fishing reel as claimed in claim 4, wherein said resistance-adjusting unit further includes a cam member driven by said rotary knob to rotate and having a plurality of cam faces, a follower formed with a plurality of integral projecting rods and driven by said cam member to move along the axis, a driven plate disposed between said follower and said brake plate and connected fixedly to and parallel to said brake plate, a plurality of parallel guide pins extending through said follower and said driven plate for guiding movement of said follower and said driven plate along said axis, and a spring unit disposed between said follower and said driven plate for biasing said brake plate to press against said brake disk, and a resilient member for biasing said projecting rods of said follower to contact respectively said cam faces of said cam member, said follower, said spring unit, and said driven plate constituting cooperatively said movable member, said rotary knob having an actuator portion and a gear portion, said cam member further having two opposite side surfaces, an annular peripheral surface interconnecting outer peripheries of said side surfaces, a plurality of guide slots formed in one of said side surfaces and defined respectively by said cam faces so as to allow said projecting rods to move respectively within said guide slots in said cam member, and a sector gear disposed fixedly on said peripheral surface and meshing with said gear portion of said rotary knob.

6. The fishing reel as claimed in claim 5, wherein said resistance-adjusting unit further includes a cylindrical receiving member for receiving said follower, said driven plate, and said spring unit.

7. The fishing reel as claimed in claim 6, wherein said second brake device further includes a clutch unit and a unidirectional bearing sleeved movably on said spool, said clutch unit includes an operating member disposed movably on said housing, an inner coupler sleeved fixedly on said unidirectional bearing and driven by said operating member to move along the axis, and an outer coupler connected fixedly to said brake disk and having an internal tooth portion, said inner coupler having an external tooth portion movable to engage said internal tooth portion of said outer coupler, said operating member being movable relative to said housing between a non-depressed position whereat said external tooth portion of said inner coupler engages said internal tooth portion of said outer coupler, and a depressed position whereat said external tooth portion of said inner coupler is removed from said internal tooth portion of said outer coupler.

8. The fishing reel as claimed in claim 7, wherein said clutch unit of said second brake device further includes a pushing member connected fixedly to said operating member, and a first spring disposed between said pushing member and said inner coupler, said first spring being compressed to push and remove said inner coupler from said outer coupler when said operating member is moved from said non-depressed position to said depressed position.

9. The fishing reel as claimed in claim 8, wherein said second brake device further includes a positioning unit for maintaining said operating member in said depressed position, said positioning unit including a stepped member interconnecting fixedly said operating member and said pushing member, and a sliding plate movable relative to said housing in a direction perpendicular to said axis, said stepped member having a large-diameter portion and a small-diameter portion that is connected between said operating member and said large-diameter portion and that has a diameter smaller than those of said operating member and said large-diameter portion, said sliding plate having a hole, said stepped member extending through said hole in said sliding plate and biased to a non-clicking position to thereby abut against said large-diameter portion of said stepped member when said operating member is disposed at said non-depressed position, said sliding plate being biased to a clicking position to thereby abut against said small-diameter portion of said stepped member so as to be confined between said operating member and said large-diameter portion, thereby preventing removal of said external tooth portion of said inner coupler from said internal tooth portion of said outer coupler when said operating member is disposed at said depressed position.

10. The fishing reel as claimed in claim 9, wherein:
said positioning unit of said second brake device further includes a reset knob disposed rotatably on said housing and connected to said sliding plate such that movement of said sliding plate from said non-clicking position to said clicking position results in rotation of said reset knob relative to said housing from a first position to a second position in a forward direction, and a plurality of return springs for biasing said reset knob to rotate relative to said housing in the forward direction, said reset knob being operable to rotate from the second position to a third position in a reverse direction opposite to the forward direction such that said reset knob rotates past the second position, thereby allowing said rest knob to be biased by said return springs to rotate to the first position in the reverse direction; and
said clutch unit of said second brake device further includes a second spring for biasing said external tooth portion of said inner coupler to engage said internal tooth portion of said outer coupler when said reset knob is disposed in the third position, said first spring having a modulus of elasticity larger than that of said second spring.

11. The fishing reel as claimed in claim 10, wherein said reset knob is circular, and is formed with a slide slot extending in a direction inclined relative to a radial direction of said reset knob, and said sliding plate is formed with a guiding rod engaging slidably said slide slot in said reset knob so that movement of said sliding plate from said non-clicking position to said clicking position results in rotation of said reset knob relative to said housing from said first position to said second position in said forward direction.
